(19) United States
(12) Patent Application Publication
(10) Pub. No.: US 2004/0170126 A1
(43) Pub. Date: Sep. 2, 2004

(54) Method for allocating data packet flow

(76) Inventor: Shing Chuang, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/757,969

(22) Filed: Jan. 15, 2004

(30) Foreign Application Priority Data
Jan. 15, 2003 (TW) 092100793

(51) Int. Cl. H04L 12/26

(52) U.S. Cl. 370/230

(57) ABSTRACT

A method is used for allocating data packet flows among a plurality of data channels of a network node. First of all, the data packets to be transmitted via the data channels are classified into a plurality of data packet flows, wherein a first data packet flow queues in a first data channel to be transmitted, and a second data packet flow is assigned to the first data channel behind the first data packet flow. The second data packet flow is then transferred from the first data channel to another data channel to be transmitted when the amounts of the first data packet flow, the second data packet flow and a third data packet flow queuing in the another data channel comply with a predetermined relationship. Meanwhile, a broadcast data packet is transmitted after the first data packet flow via the first data channel. In response to the broadcast data packet, the second data packet is transmitted via another data channel.

### FIELD OF THE INVENTION

The present invention relates to a method for allocating data packet flows, and more particularly to a method for allocating data packet flows among a plurality of data channels in a network system.

### BACKGROUND OF THE INVENTION

Network switches are widely used to interconnect a plurality of nodes, e.g. computers and/or equivalent devices such as network printers or network attached storages, for the purpose of sharing open sources. In a conventional local network architecture shown in FIG. 1, a network switch 10 interconnects a plurality of network nodes B1˜Bm via a plurality of input/output ports A1˜An thereof. If the number of the network nodes B1˜Bm is less than that of the I/O ports A1˜An of the network switch 10, some of the I/O ports A1˜An will be idle. On the other hand, even if all the I/O ports A1˜An are in use, temporary idle situation of some I/O ports is frequently rendered because of imbalanced transmission. For example, when one or more network nodes linking to the switch 10 require higher bandwidths than the other, the data fluxes are imbalanced for the I/O ports. This situation would happen to, for example, a server in a client/server configuration. For a network switch designed to have bandwidth equally shared by all the I/O ports, some I/O ports will become idle while other I/O ports are busy with data transmission.

For making use of the bandwidth and I/O ports of the network switch, another local network architecture was developed, as shown in FIG. 2, to provide more data channels for the network nodes requiring higher bandwidth. Likewise, a network switch 20 interconnects a plurality of network nodes, and only one network node 21 is shown in FIG. 2. The network node 21, for example a personal computer acting as a server which requires high bandwidth, is plugged therein three network cards 211˜213, and the network switch 20 communicates with the network node 21 via a corresponding number of input/output ports 201˜203. In other words, three data channels are formed with the ports 201˜203 and the network cards 211˜213. In such way, the bandwidth of the network node 21 is tripled with the increase of the data channels.

In operation, the network interface card driver of the network node 21 classifies the data packets into several types, and specified types of data packets are transmitted through designated data channels. For example, the data packets are classified into nine types, and the network interface card driver allocates the type-1, the type-4 and the type-7 data packets to the network card 211, the type-2, the type-5 and the type-8 data packets to the network card 212, and the type-3, the type-6 and the type-9 data packets to the network card 213. In this network node 21 with tripled bandwidth, the temporary idle status is still likely to happen because the data transmission amounts of all the data channels are not completely the same. For example, if the type-1, the type-4 and the type-7 data packets are much more than the other types of data packets, the data channel constructed by the network card 211 and the port 201 much more crowded than the other data channels. In other words, the other two data channels become idle while the first data channel is still busy in transmitting data packets. Therefore, unbalanced data loading is rendered.

### SUMMARY OF THE INVENTION

The present invention provides a method for allocating data packet flows among a plurality of data channels of a network node in a network system, which optionally changes transmission path of the data packet flows according to data loading of each data channel, so as to make use of all the data channels and improve the data transmission efficiency.

A first aspect of the present invention relates to a method for allocating data packet flows among a plurality of data channels of a network node. The method comprises steps of: classifying data packets to be transmitted via the data channels into a plurality of data packet flows, wherein a first data packet flow is assigned to and then queues in a first data channel to be transmitted; obtaining a first flow index according to the amount of a first data packet flow queuing in the first data channel, and the amount of a second data packet flow assigned to the first data channel; and determining whether the second data packet flow is to be transferred from the first data channel to another data channel for being transmitted according to a comparing result of the first flow index and a threshold value.

Preferably, the step of classifying the data packets into the data packet flows comprises sub-steps of: performing an operation of a specified tag value included in each of the data packets to obtain respective feature values of the data packets; and classifying the data packets having the same feature value in the same data packet flow.

Preferably, the tag value comprises a destination media access control (DMAC) address, an internet protocol (IP) address and a transmission control protocol (TCP) address.

Preferably, the operation is an exclusive OR (XOR) operation.

Preferably, the second data packet flow is the one assigned to the first data channel and having the least data packet amount at a certain time point.

In one embodiment, the first flow index is the sum of the amount of the first and the second data packet flows.

In one embodiment, the above transference determining step comprises sub-steps of: obtaining a second flow index according to the amount of the second data packet flow and the amount of a third data packet flow queuing in a second data channel where the second data packet flow is to be transferred when the first flow index is greater than the threshold value; and transferring the second data packet flow from the first data channel to the second data channel to be transmitted when the second flow index is no greater than the threshold value.

Alternatively, the above transference determining step comprises sub-steps of: obtaining a second flow index according to the amount of the second data packet flow and the amount of a third data packet flow queuing in a second data channel where the second data packet flow is to be transferred when the first flow index is greater than the threshold value; and remaining the second data packet flow to be assigned to the first data channel when the second flow index is greater than the threshold value.

Preferably, the above transference determining step comprises sub-steps of: obtaining a second flow index according to the amount of the second data packet flow and the amount of a third data packet flow queuing in a second data channel where the second data packet flow is to be transferred when the first flow index is greater than the threshold value; transferring the second data packet flow from the first data channel to the second data channel to be transmitted when the second flow index is no greater than the threshold value; and remaining the second data packet flow to be assigned to the first data channel when the second flow index is greater than the threshold value.

Preferably, the second data channel has the least amount of data packets in queue than the other data channels at a certain time point.

Preferably, the transference determining step is repetitively performed at a constant interval.

Preferably, the method further comprises a step of transmitting a broadcast data packet after the first data packet flow via the first data channel when the second data packet flow is determined to be transferred from the first data channel to a second data channel.

In one embodiment, the second data packet flow starts to be transferred via the second data channel after the broadcast data packet is received by at least one of the data channels.

Alternatively, the second data packet flow starts to be transferred via the second data channel after a preset time period from the transmission of the broadcast data packet via the first data channel.

Preferably, the second data packet flow starts to be transferred via the second data channel after the broadcast data packet is received by at least one of the data channels, and if there is no data channel receiving the broadcast data packet at the end of a preset time period, the second data packet flow starts to be transferred via the second data channel.

Preferably, the broadcast data packet comprises an identifying code of the second data packet flow.

According to a second aspect of the present invention, the method for allocating data packet flows among a plurality of data channels of a network node comprises steps of: classifying data packets to be transmitted via the data channels into a plurality of data packet flows, wherein a first data packet flow queues in a first data channel to be transmitted, and a second data packet flow is assigned to the first data channel behind the first data packet flow; transferring the second data packet flow from the first data channel to another data channel to be transmitted and transmitting a broadcast data packet after the first data packet flow via the first data channel when the amounts of the first data packet flow, the second data packet flow and a third data packet flow queuing in the another data channel comply with a predetermined relationship; and transmitting the second data packet in response to the broadcast data packet.

In one embodiment, the predetermined relationship is that the sum of the amounts of the first data packet flow and the second data packet flow is greater than a threshold value, and the sum of the amounts of the third data packet flow and the second data packet flow is no greater than a threshold value. Preferably, the second data packet flow starts to be transferred after the broadcast data packet is received by at least one of the data channels, and if there is no data channel receiving the broadcast data packet at the end of a preset time period, the second data packet flow also starts to be transferred.

The above contents and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic block diagram illustrating a conventional local network architecture;

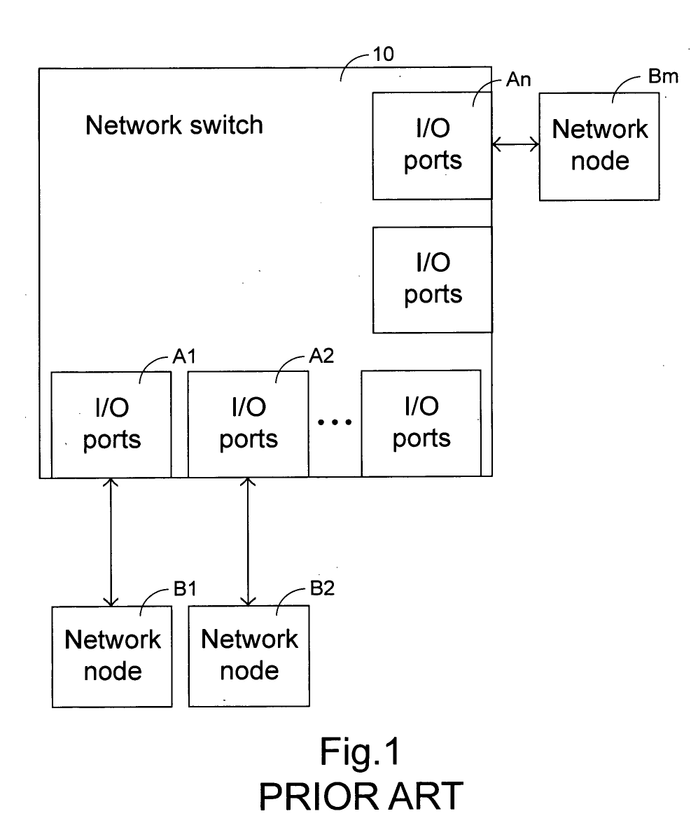

FIG. 2 is a schematic block diagram illustrating another conventional local network architecture;

FIG. 3 is a schematic block diagram illustrating a local network architecture implementing the method for allocating data packet flows according to the present invention; and

FIG. 4 is a flowchart illustrating the method for allocating data packet flows according to an embodiment of the present invention.

### DETAILED DESCRIPTION OF THE PREFERRED EMBODIMENT

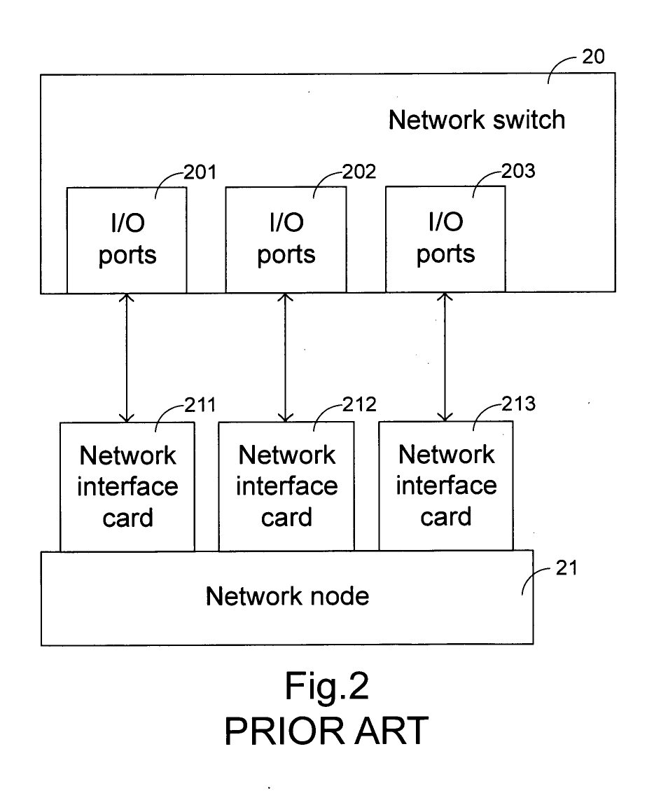

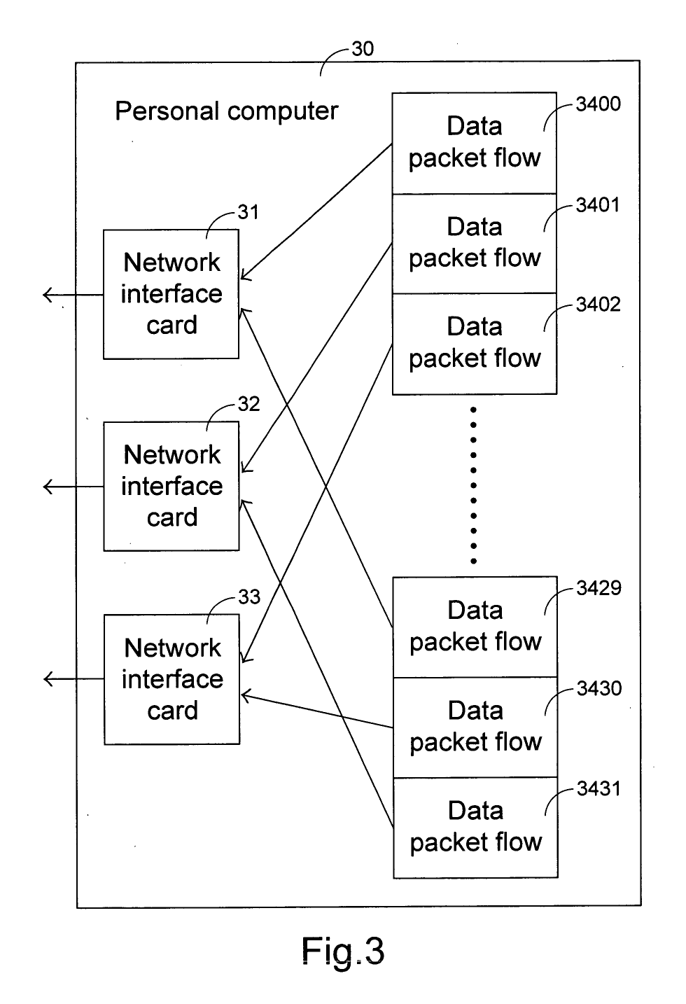

The method for allocating data packet flows among a plurality of data channels according to the present invention can be used in a local network architecture as shown in FIG. 3. As shown, a personal computer 30 has thereon three network interface cards 31, 32 and 33, which are controlled by a driver program of the personal computer 30. By connecting the network interface cards 31, 32 and 33 to the I/O ports of the network switch (not shown, referring to the numeral reference 201˜203 of FIG. 2), respectively, three data channels are formed. The driver program classifies the data packets generated by the operation system of the personal computer 30 into a plurality of data packet flows. The group number of the data packet flows depends on the operational capacity of the personal computer 30. For example, the driver program extracts a specified tag value from each of the data packets. The tag value includes a destination media access control (DMAC) address, an internet protocol (IP) address and a transmission control protocol (TCP) address. Each specified tag value performs an XOR operation to result in a 5-bit hash value, which is defined by DMAC⊕IP⊕TCP. According to the hash value, each data packet is classified into one of the 32 types of data packet flows 3400, 3401, . . . , 3431.

In the beginning, the data packet flows are transmitted from network interface cards in a predetermined manner. That is, that a data packet will be transmitted via which of the three network interface cards 31, 32 and 33 is determined according to the classes thereof. Afterwards, for dynamically balancing the load of the three network interface cards 31, 32 and 33, that a data packet will be transmitted via which of the three network interface cards 31, 32 and 33 is determined according to the flow amounts of those network interface cards.

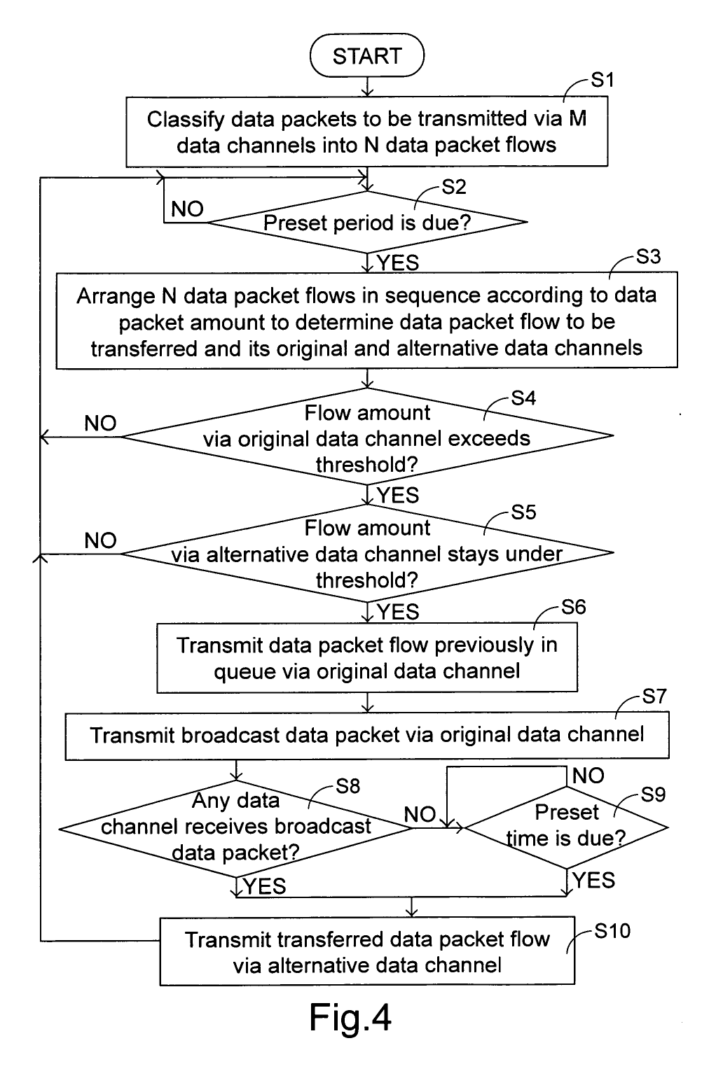

An example will be illustrated hereinafter with reference to the flowchart of FIG. 4. After the data packets are classified in Step S1, the three network interface cards 31, 32 and 33 having equal bandwidths have data packet flows of 700 kb, 600 kb and 500 kb in queue, respectively. At an interval, e.g. 0.1 second, the data packet flows are rearranged in sequence according to data packet amount (Steps S2 and S3). Accordingly, a data packet flow having the least data packet amount is selected, and the original network interface card that it should be assigned to is determined according to the class thereof. In case that the flow amount of the original network interface card is too large, the selected data packet flow should be transferred to an alternative network interface card to be transmitted (Step S4). The alternative network interface card is preferably the one having the least data packet amount in queue. In this example, the selected data packet flow has amount of 200 kb, and is originally assigned to the network interface card 31. Since the sum of the amount 700 kb of the data packet flow in queue and the amount 200 kb of the selected data packet flow is greater than a preset threshold 800 kb, it is understood that the load of the network interface card 31 will be too large. Therefore, it is considered to transfer the selected data packet flow from the original network interface card 31 to the alternative network interface card 33. Of course, the load of the alternative network interface card 33 should also be taken into consideration in advance. The transference of the selected data packet flow will not be performed unless the load of the alternative network interface card 33 is under the threshold (Step 5). In this example, the sum of the amount 500 kb of the data packet flow in queue and the amount 200 kb of the selected data packet flow is less than the preset threshold 800 kb, so the selected data packet can be suitably transferred to the alternative network interface card 33 to be transmitted.

Since the transmission rates of the data channels differ from one another, the transmission of said transferred data packet flow should be started at proper timing in order to assure of the sequential accuracy. In order to achieve this purpose, the present invention additionally transmits a broadcast data packet (Step S7) after the data packet flow previously queuing in the network interface card 31 is transmitted (Step S6). The broadcast data packet contains an identifying code of the transferred data packet flow. Once any of the network interface cards 31, 32 and 33 receives the broadcast data packet (Step S8), the transferred data packet flow starts to be transmitted via the alternative network interface card 33 (Step S10). In this manner, the transferred data packet flow transmitted via the network interface card 33 will follow the previous data packet flow transmitted via the network interface card 31.

In some case, however, the broadcast data packet is possibly cast away so that none of the network interface cards 31, 32 and 33 will receive the broadcast data packet. In order to start the transmission of the transferred data packet flow even if the broadcast data packet is lost, a timing operation begins at the transference of the selected data packet flow, e.g. the insertion of the broadcast data packet behind the data packet flow in queue of the network interface card 31. If the broadcast data packet is not received by any of the network interface cards 31, 32 and 33 after the timing operation completes (Step S9), the transferred data packet flow will also be transmitted via the network interface card 33.

It is understood from the above description that the imbalanced load of the data channels can be improved by transferring data packet flows from a busy data channel to an idle data channel. The present allocating method makes use of the data channels and improve the data transmission efficiency.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for allocating data packet flows among a plurality of data channels of a network node, comprising steps of:
classifying data packets to be transmitted via said data channels into a plurality of data packet flows, wherein a first data packet flow is assigned to and then queues in a first data channel to be transmitted;
obtaining a first flow index according to the amount of a first data packet flow queuing in said first data channel, and the amount of a second data packet flow assigned to said first data channel; and
determining whether said second data packet flow is to be transferred from said first data channel to another data channel to be transmitted according to a comparing result of said first flow index and a threshold value.

2. The method according to claim 1 wherein said step of classifying said data packets into said data packet flows comprises sub-steps of:
performing an operation of a specified tag value included in each of said data packets to obtain respective feature values of said data packets; and
classifying the data packets having the same feature value in the same data packet flow.

3. The method according to claim 2 wherein said tag value includes a destination media access control (DMAC) address, an internet protocol (IP) address and a transmission control protocol (TCP) address.

4. The method according to claim 2 wherein said operation is an exclusive OR (XOR) operation.

5. The method according to claim 1 wherein said second data packet flow is the one assigned to said first data channel and having the least data packet amount at a certain time point.

6. The method according to claim 1 wherein said first flow index is the sum of the amount of said first and said second data packet flows.

7. The method according to claim 1 wherein said transference determining step comprises sub-steps of:
obtaining a second flow index according to the amount of said second data packet flow and the amount of a third data packet flow queuing in a second data channel where said second data packet flow is to be transferred when said first flow index is greater than said threshold value; and
transferring said second data packet flow from said first data channel to said second data channel to be transmitted when said second flow index is no greater than said threshold value.

8. The method according to claim 1 wherein said transference determining step comprises sub-steps of:
obtaining a second flow index according to the amount of said second data packet flow and the amount of a third data packet flow queuing in a second data channel where said second data packet flow is to be transferred when said first flow index is greater than said threshold value; and
remaining said second data packet flow to be assigned to said first data channel when said second flow index is greater than said threshold value.

9. The method according to claim 1 wherein said transference determining step comprises sub-steps of:
obtaining a second flow index according to the amount of said second data packet flow and the amount of a third data packet flow queuing in a second data channel where said second data packet flow is to be transferred when said first flow index is greater than said threshold value;
transferring said second data packet flow from said first data channel to said second data channel to be transmitted when said second flow index is no greater than said threshold value; and
remaining said second data packet flow to be assigned to said first data channel when said second flow index is greater than said threshold value.

10. The method according to claim 9 wherein said second data channel has the least amount of data packets in queue than the other data channels at a certain time point.

11. The method according to claim 1 wherein said transference determining step is repetitively performed at a constant interval.

12. The method according to claim 1 further comprising a step of transmitting a broadcast data packet after said first data packet flow via said first data channel when said second data packet flow is determined to be transferred from said first data channel to a second data channel.

13. The method according to claim 12 wherein said second data packet flow starts to be transferred via said second data channel after said broadcast data packet is received by at least one of said data channels.

14. The method according to claim 12 wherein said second data packet flow starts to be transferred via said second data channel after a preset time period from the insertion of said broadcast data packet to be transmitted via the first data channel.

15. The method according to claim 12 wherein said second data packet flow starts to be transferred via said second data channel after said broadcast data packet is received by at least one of said data channels, and if there is no data channel receiving said broadcast data packet at the end of a preset time period, said second data packet flow starts to be transferred via said second data channel.

16. The method according to claim 15 wherein said broadcast data packet comprises an identifying code of said second data packet flow.

17. A method for allocating data packet flows among a plurality of data channels of a network node, comprising steps of:
classifying data packets to be transmitted via said data channels into a plurality of data packet flows, wherein a first data packet flow queues in a first data channel to be transmitted, and a second data packet flow is assigned to said first data channel behind said first data packet flow;
transferring said second data packet flow from said first data channel to another data channel to be transmitted and transmitting a broadcast data packet after said first data packet flow via said first data channel when the amounts of said first data packet flow, said second data packet flow and a third data packet flow queuing in said another data channel comply with a predetermined relationship; and
transmitting said second data packet in response to said broadcast data packet.

18. The method according to claim 17 wherein said predetermined relationship is that the sum of the amounts of said first data packet flow and said second data packet flow is greater than a threshold value, and the sum of the amounts of said third data packet flow and said second data packet flow is no greater than a threshold value.

19. The method according to claim 17 wherein said second data packet flow starts to be transferred after said broadcast data packet is received by at least one of said data channels, and if there is no data channel receiving said broadcast data packet at the end of a preset time period, said second data packet flow also starts to be transferred.

20. The method according to claim 17 wherein said second data packet flow is the one assigned to said first data channel and having the least data packet amount at a certain time point.

21. The method according to claim 17 wherein said broadcast data packet comprises an identifying code of said second data packet flow.
